(19) United States
(12) Patent Application Publication
(10) Pub. No.: US 2009/0056624 A1
(43) Pub. Date: Mar. 5, 2009

(54) FLUID CIRCULATING SYSTEM FOR MANUFACTURING PRINTED CIRCUIT BOARD

(75) Inventors: CHIH-KANG YANG, Tayuan (TW); HUNG-YI CHANG, Tayuan (TW); CHIH-LUNG HSIAO, Tayuan (TW); TUNG-YAO KUO, Tayuan (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN ADVANCED TECHNOLOGY INC., Tayuan (TW)

(21) Appl. No.: 12/045,150

(22) Filed: Mar. 10, 2008

(30) Foreign Application Priority Data
Aug. 31, 2007 (CN) 200710076763.4

(51) Int. Cl. B05C 3/04

(52) U.S. Cl. 118/410

(57) ABSTRACT

An exemplary fluid circulating system includes a return pipe, a reservoir, a suction pipe, a supply pipe, a circulating pump, and a processing device. The reservoir is configured for containing a work fluid. The processing device is configured for processing a semi-finished printed circuit board using the work fluid. The circulating pump is configured for transferring the work fluid from the reservoir to the processing device. The suction pipe and the supply pipe are respectively coupled to an inlet and the outlet of the circulating pump. An inner diameter of the suction pipe is larger than that of the supply pipe. The return pipe is coupled to the processing device for delivering the work fluid from the processing device to the reservoir. The fluid circulating system can improve quality of the circulated work fluid.

### BACKGROUND

1. Technical Field

The present invention relates to fluid circulating systems, particularly to a fluid circulating system for circulating a work fluid used in a process for manufacturing a printed circuit board.

2. Description of Related Art

Printed circuit boards are widely used in electronic products. Printed circuit boards are usually manufactured in a series of processes including drilling holes, manufacturing electrical traces, applying photoresist, printing legends, and electroplating gold on terminals. In these processes, various fluids such as water, liquid photoresist, and electroplating solution are used. As a result, an amount of waste fluid is generated, which may cause serious environment pollution. Nowadays, people pay more attention to dealing with the waste fluid than before. The fluid used in the series of processes for manufacturing printed circuit boards is generally used circularly. Thus, not only the waste fluid is reduced to facilitate environmental protection, but also cost of manufacturing printed circuit boards is saved.

Referring to FIG. 3, a typical fluid circulating system 300 includes a return pipe 310, a reservoir 320, a suction pipe 330, a circulating pump 340, a supply pipe 350, and a processing device 380. An inner diameter of the suction pipe 340 and that of the supply pipe 350 are typically identical. The excess fluid remaining in the processing device 380 flows into the reservoir 320 through the return pipe 310, and then is pumped into the circulating pump 340 through the suction pipe 330, and finally, it is pumped into the processing device 380 through the supply pipe 350 from the circulating pump 340 to be used again. For example, in a process of applying photoresist during manufacturing of a printed circuit board, a liquid photoresist is applied to a surface of a copper clad substrate. Any excess liquid photoresist enters the typical fluid circulating system 300 to circulate, and then it can be used to apply to a surface of another copper clad substrate.

However, when the liquid photoresist enters the circulating pump 340 through the suction pipe 330, system pressure decreases because the pressure in the circulating pump 340 is generally less than the pressure in the suction pipe 330. As a result, solubility of air of the liquid photoresist decreases with decrease in system pressure, thereby generating a number of air bubbles in the circulating pump 340, which can cause cavitation erosion. Additionally, if the liquid photoresist having air bubbles therein is applied to the surface of a copper clad substrate, the air bubbles will affect uniformity of a liquid photoresist layer formed, thereby affecting quality of the printed circuit board. Therefore, the typical circulating system 300 cannot satisfy demands of printed circuit board manufacturing.

What is needed, therefore, is a fluid circulating system for circulating a fluid used in a process for manufacturing a printed circuit board so as to reduce air bubbles in the circulating process and improve quality of the circulated fluid, thereby improving quality of the printed circuit board.

### SUMMARY

One present embodiment provides a fluid circulating system. The fluid circulating system includes a return pipe, a reservoir, a suction pipe, a supply pipe, a circulating pump, and a processing device. The reservoir is configured for containing a work fluid for processing a semi-finished printed circuit board. The processing device is configured for processing the semi-finished printed circuit board using the work fluid. The circulating pump is configured for transferring the work fluid from the reservoir to the processing device. The circulating pump has an inlet and an outlet. The suction pipe has a first end for inserting into the work fluid contained in the reservoir, and an opposite second end coupled to the inlet of the circulating pump. The supply pipe has a first end coupled to the outlet of the circulating pump, and an opposite second end coupled to the processing device. An inner diameter of the suction pipe is larger than that of the supply pipe. The return pipe is coupled to the processing device and is configured for delivering the work fluid from the processing device to the reservoir.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a fluid circulating system according to a first embodiment.

FIG. 2 is a schematic view of a fluid circulating system according to a second embodiment.

FIG. 3 is a schematic view of a typical fluid circulating system.

### DETAILED DESCRIPTION OF THE EMBODIMENTS

Embodiments will now be described in detail below and with reference to the drawings.

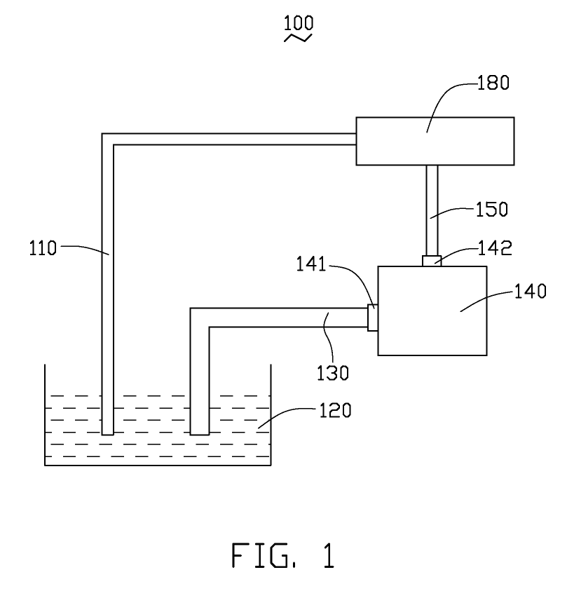

Referring to FIG. 1, an exemplary fluid circulating system 100 according to a first embodiment is shown. The fluid circulating system 100 includes a return pipe 110, a reservoir 120, a suction pipe 130, a circulating pump 140, a supply pipe 150, and a processing device 180.

The return pipe 110 is configured for delivering a work fluid from the processing device 180 into the reservoir 120. Therefore, one end of the return pipe 110 is coupled to the processing device 180, and the other end of the return pipe 110 is disposed in any position at the reservoir 120 where the work fluid can be introduced into the reservoir 120. In application, the work fluid is used for processing a semi-finished circuit board located at the processing device 180, and the excess work fluid can flow into the reservoir 120 through the return pipe 110. The semi-finished printed circuit board can be a copper clad substrate needing liquid photoresist applied thereon, a circuit substrate that has a number of electrical traces formed thereon, and so on.

The reservoir 120 is configured for containing the work fluid for the processing device 180 which can be used again. The circulating pump 140 has an inlet 141 and an outlet 142 for the work fluid. The circulating pump 140 is configured for transferring the work fluid from the reservoir 120 to the processing device 180. The work fluid can be pumped into the circulating pump 140 through the inlet 141 and be pumped out of the circulating pump 140 through the outlet 142.

The suction pipe 130 has a uniform inner diameter. The suction pipe 130 has a first end and an opposite second end. The first end of the suction pipe 130 is inserted into the work fluid contained in the reservoir 120, and the opposite second end of the suction pipe 130 is coupled to the inlet 141 of the circulating pump 140. The suction pipe 140 is configured for guiding the work fluid out of the reservoir 120 and into the circulating pump 140.

The supply pipe 150 has a uniform inner diameter. The suction pipe 130 has a first end and an opposite second end. The first end of the supply pipe 150 is coupled to the outlet 142 of the circulating pump 140, and the opposite second end of the supply pipe 150 is coupled to the processing device 180. The supply pipe 150 is configured for guiding the work fluid out of the circulating pump 140 into the processing device 180.

The inner diameter of the suction pipe 130 is larger than that of the supply pipe 150. A ratio of the inner diameter of the suction pipe 130 to the supply pipe 150 is in a range from about 1.5 to about 2.0. Preferably, the ratio of the inner diameter of the suction pipe 130 to the supply pipe 150 is in a range from about 1.6 to about 1.8.

In the present fluid circulating system 100, it can be shown there are at least two points where air solubility of work fluid circulating in the fluid circulating system 100 will be affected by changes in pressure. A first change occurring when the circulating work fluid is introduced into the relatively larger circulating pump 140 via the relatively smaller suction pipe 130 at which time the pressure decreases because of the size of the circulating pump 140 compared to the suction pipe 130 thus introducing air bubbles into the circulating work fluid because of a reduction in air solubility. When the circulating work fluid leaves the circulating pump 140 via the supply pipe 150 a second change in pressure occurs wherein pressure is increased because the circulating work fluid is traveling from the relatively larger circulating pump 140 to the relatively smaller supply pipe 150 thus air solubility of the circulating work fluid increases causing the reabsorption of air bubbles into the circulating work fluid.

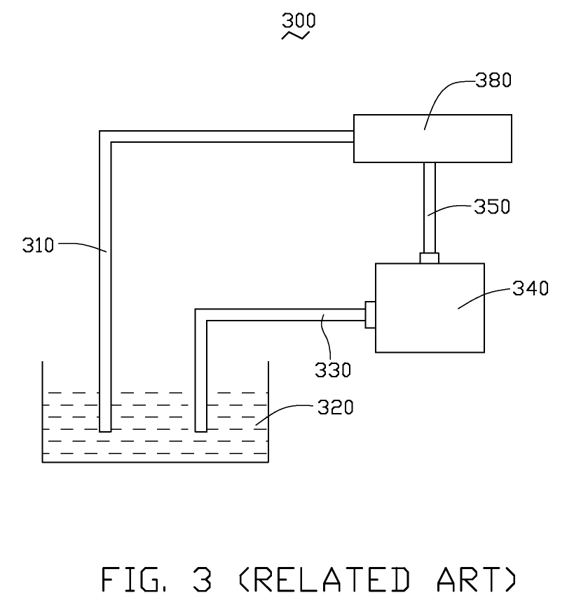

However, in practice when using a typical fluid circulating system 300 (see FIG. 3) the second change is not enough to cause all the air bubbles introduced into the circulating work fluid, from the time of the first change, to be reabsorbed although the two changes in air solubility should cancel each other out because of pipes 330, 350 having the same inner diameter. Other changes may occur between the time of the two changes that effect the air solubility of the circulating work fluid such as an increase in temperature of the circulating work fluid brought about by action of the circulating pump 340, which would decrease the air solubility of the circulating work fluid, further increasing the number of air bubbles introduced into the circulating work fluid.

In the present fluid circulating system 100, by controlling the ratio of the difference in inner diameters of the pipes 130, 150, the second change can be controlled to be great enough to reduce if not eliminate the bubbles introduced into the circulating work fluid from the time of the first change to the time of the second change.

The processing device 180 is coupled to the return pipe 110 and the supply pipe 150 respectively. The processing device 180 is configured for processing the semi-finished printed circuit board using the work fluid. For example, when the fluid circulating system 100 is used in a process of applying liquid photoresist for manufacturing a printed circuit board, the processing device 180 can be a photoresist applying device configured for applying a liquid photoresist on the semi-finished printed circuit board. The work fluid is liquid photoresist. For another example, when the fluid circulating system 100 is used in a process of electroplating gold on terminals for manufacturing a printed circuit board, the processing device 180 can be an electroplating device configured for electroplating the semi-finished printed circuit board and the work fluid is electroplating solution.

Advantageously, the fluid circulating system 100 is used in a process of applying liquid photoresist for manufacturing a printed circuit board. The liquid photoresist is circulated in the fluid circulating system 100. The circulated liquid photoresist has few or no air bubbles therein. When the circulated liquid photoresist is used again, the uniformity of applying the circulated liquid photoresist can be improved, thereby improving quality of manufacturing the printed circuit board.

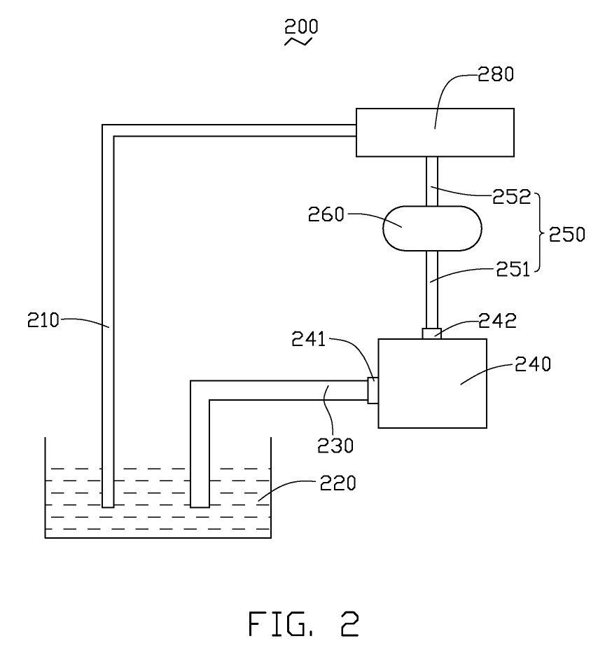

Referring to FIG. 2, an exemplary fluid circulating system 200 according to a second embodiment is shown. The fluid circulating system 200 is similar to the fluid circulating system 200. The fluid circulating system 200 includes a return pipe 210, a reservoir 220, a suction pipe 230, a circulating pump 240, a supply pipe 250, a filter device 260, and a processing device 280.

Particularly, the supply pipe 250 includes a first pipe 251 and a second pipe 252. One end of the first pipe 251 is coupled to the outlet 242 of the circulating pump 240, and the other end of the first pipe 251 is coupled to the filter device 260. The first pipe 251 is configured for guiding the work fluid out of the circulating pump 240 into the filter device 260. One end of the second pipe 252 is coupled to the filter device 260, and the other end of the second pipe 252 is coupled to the processing device 280. The second pipe 252 is configured for guiding the work fluid from the filter device 260 into the processing device 280. An inner diameter of the first pipe 251 is equal to that of the second pipe 252. According to the principle of reducing air bubbles as described above, it is noted that the inner diameter of the first pipe 251 can be larger than of the second pipe 252.

The filter device 260 connected between the first pipe 251 and the second pipe 252 is configured for filtering impurities from the circulating work fluid from the outlet 242 of the circulating pump 240, thereby improving quality of the work fluid delivered to the processing device 280.

An inner diameter of the suction pipe 230 is larger than that of the supply pipe 240. In detail, a ratio of the inner diameter of the suction pipe 230 to the first pipe 251 is in a range from about 1.5 to about 2.0. Preferably, the ratio of the inner diameter of the suction pipe 230 to the first pipe 251 is in a range from about 1.6 to about 1.8. A ratio of the inner diameter of the suction pipe 230 to the second pipe 252 is in a range from about 1.5 to about 2.0. Preferably, the ratio of the inner diameter of the suction pipe 230 and the second pipe 252 is in a range from about 1.6 to about 1.8. It is critical for reducing air bubbles generated in the circulating process to ensure the inner diameter of the suction pipe 130 is larger than that of the first pipe 251 and the second pipe 252. In the present embodiment, the inner diameters of the first pipe 251 and the second pipe 252 are selected so that the ratios of the inner diameter of the suction pipe 130 to the first pipe 251 or to the second pipe 252 are in a range from about 1.5 to about 2.0, preferably, in a range from about 1.6 to about 1.8.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A fluid circulating system for manufacturing a printed circuit board, comprising:
a reservoir for containing a work fluid for processing a semi-finished printed circuit board,
a processing device for processing the semi-finished printed circuit board using the work fluid,
a circulating pump for transferring the work fluid from the reservoir to the processing device, the circulating pump having an inlet and an outlet,
a suction pipe having a first end for inserting into the work fluid contained in the reservoir, and an opposite second end coupled to the inlet of the circulating pump,
a supply pipe having a first end coupled to the outlet of the circulating pump, and an opposite second end coupled to the processing device, an inner diameter of the suction pipe being larger than that of the supply pipe, and
a return pipe coupled to the processing device for delivering the work fluid from the processing device to the reservoir.

2. The fluid circulating system as claimed in claim 1, wherein a ratio of the inner diameter of the suction pipe to the supply pipe is in a range from about 1.5 to about 2.0.

3. The fluid circulating system as claimed in claim 1, wherein a ratio of the inner diameter of the suction pipe to the supply pipe is in a range from about 1.6 to about 1.8.

4. The fluid circulating system as claimed in claim 1, wherein the supply pipe comprises a first pipe and a second pipe, the fluid circulating system further comprises a filter device for filtering out impurity in the work fluid, one end of the first pipe is coupled to the outlet of the circulating pump, the other end of the first pipe is coupled to the filter device, one end of the second pipe is coupled to the filter device, the other end of the second pipe is coupled to the processing device.

5. The fluid circulating system as claimed in claim 4, wherein an inner diameter of the first pipe is equal to that of the second pipe.

6. The fluid circulating system as claimed in claim 4, wherein an inner diameter of the first pipe is larger than of the second pipe.

7. The fluid circulating system as claimed in claim 4, wherein a ratio of the inner diameter of the suction pipe to the first pipe is in a range from about 1.5 to about 2.0.

8. The fluid circulating system as claimed in claim 7, wherein a ratio of the inner diameter of the suction pipe to the first pipe is in a range from about 1.6 to about 1.8.

9. The fluid circulating system as claimed in claim 7, wherein a ratio of the inner diameter of the suction pipe to the second pipe is in a range from about 1.5 to about 2.0.

10. The fluid circulating system as claimed in claim 9, wherein a ratio of the inner diameter of the suction pipe to the second pipe is in a range from about 1.6 to about 1.8.

11. The fluid circulating system as claimed in claim 1, wherein the processing device is configured for applying a liquid photoresist on the semi-finished printed circuit board.
